(19) United States
(12) Patent Application Publication
(10) Pub. No.: US 2010/0265209 A1
(43) Pub. Date: Oct. 21, 2010

(54) POWER REDUCTION FOR TOUCH SCREENS

(75) Inventors: Juha Harri-Pekka Nurmi, Salo (FI); Kaj Saarinen, Tokyo (JP); Tero Juhani Rautanen, Turku (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/746,732

(22) PCT Filed: Dec. 6, 2007
(86) PCT No.: PCT/EP2007/063390

§ 371 Date: Jun. 7, 2010

(51) Int. Cl. G06F 3/038

(52) U.S. Cl. 345/174

(57) ABSTRACT

This specification relates to determining areas within touch screen, where a user input is possible. To reduce power consumption of a device with a touch screen, touch detection for sensing a user input is only activated within the determined areas, where a user input is possible.

### TECHNICAL FIELD

This specification relates to activation of touch detection within a touch screen.

### BACKGROUND

Within portable information terminals, for example PDAs, laptops, tablet PCs, video players, music players, multimedia players, cameras, mobile phone, and the like, touch screens for receiving user input are emerging into the market.

Touch screens for receiving user input may be understood as touch sensible input screens, which are arranged to detect a user input from depressing a screen which displays user information. Touch screens may be a combination of a display arranged below a touch sensitive sheet, which is capable of sensing the location of contact with a finger or a pen. Also, touch screens may be a combination of a display arranged with a touch sensitive switch matrix, e.g. a display integrated touch screen, which is capable of sensing the location of contact with a finger, a pen or any other object. A touch screen may receive user inputs, for example pressing a button or an icon, or selecting certain areas, writing memos, selecting programs, and the like within a user interface of a computer program.

In order to process the user input, a microprocessor, e.g. a drive engine, which is responsible for the operation of the portable information terminal, i.e. the computer program running on the terminal, needs to receive the detected user inputs and convert them into the appropriate program instructions. In order to receive the user inputs, the drive engine responsible for the operation of the information terminal needs to receive the signals from the touch screen, and to convert these signals into the appropriate program logic.

For being able to receive and process the signals received from the touch screen, respectively a microprocessor operating the touch screen, e.g. a touch screen engine, the drive engine needs to dedicate at least parts of its processing power to the touch screen engine. The drive engine may operate, besides the touch screen, also loudspeakers, transmission and reception antennas and modules, for example for wireless communication, e.g. GSM, UMTS, WiFi, Near Field Communication (NFC), Bluetooth and the like, keyboards, global positioning devices (GPS), microphones, camera devices, display devices, multimedia processors, and the like. All of these devices may be operated by the drive engine and the interoperation between the devices is controlled by the drive engine.

In case the drive engine is required to process signals from the touch screen, the touch screen engine may issue an interrupt for the drive engine. Upon reception of the interrupt, the drive engine may dedicate at least a part of its processing power to the touch screen and/or the touch screen engine in order to receive and process the signals received from the touch screen and/or the touch screen engine. When receiving the interrupt from the touch screen engine, the drive engine may be activated, and power consumption of the drive engine may thus increase.

For example, from U.S. Pat. No. 6,091,031, there is known a portable information terminal. The information terminal has a predetermined area of a touch screen panel, which covers a liquid crystal screen. Further, there is provided a program selection screen. The terminal may be activated by touching the program selection screen, which acts as a system activation area. The system is only activated after depressing the activation area for a predetermined time.

However, the program selection area is a predetermined area, which covers at least 10-20% of the whole area of the touch screen. Depressing the program selection area for a predetermined time inadvertently may cause the panel to be activated. Activating the system upon depressing the program selection area for a predetermined time thus may not necessarily be user initiated. The power consumption of the system thus may increases due to faulty activation.

### SUMMARY

In order to reduce power consumption, there is provided a method comprising determining areas within a touch screen, where user input is possible. Activating touch detection of the touch screen for sensing a user input only within the determined areas, where user input is possible is provided.

Areas within the touch screen, where a user input is possible, may change during changing operational states of the terminal. For example, when the terminal is in a sleep mode, a.k.a. rest state, sleep state, power save mode, or the like, there is only a small area within the whole touch screen, which may be used as activation area. This activation area may change dynamically and may cover only less then 10% of the touch screen. The activation area might be indicated by an appropriate button or icon or any other means within the display. The software running on the device with the touch screen may control the display to show the activation icon at a certain position within the touch screen. The position of the activation area may change dynamically. Determination of the area, where user input is possible, may allow for detecting automatically, and dynamically, where user input is possible at all. In other areas than the activation areas, no user input may be required and possible. User input within other areas may not be detected and may not cause issuing an interrupt. Only those areas, where user input is possible, may be determined as activation areas. The determination of the area(s), where user input is possible, may depend on the content actually shown on the display. There may be means which analyse the content shown and which determine, which areas are used as activation areas. Touch detection of the touch screen may only be activated for areas, which are determined to be possible input areas. The touch detection itself may already consume energy, as, for example, the touch state of the display needs to be analysed almost in real time. The display area needs to be activated for touch detection. By determining the areas, where user input is possible, only those areas need to be analysed, providing reduced power consumption.

For example, the display may show three different selection icons, for example “yes”, “no”, “cancel”. Only within these three icons, user input is possible. Determining the areas, where user input is possible, allows for detecting the three icons within the display. Only the areas, which are overlap with these icons may be activated for touch detection. Other areas may be temporally deactivated for touch detection. When a user uses a pen, or his finger, or any other device or means for inputting information into the device, input is only accepted within the detected areas. For example, when the user presses the touch screen outside the detected areas, no action is triggered by the drive engine. Only when the user presses the touch screen at the determined areas, the appropriate program action is triggered by the drive engine.

When triggering a program action, it may be necessary that the drive engine provides for processing power to process the program action. The touch screen or the touch screen engine may issue an interrupt for the drive engine, when sensing a user input. The interrupt provides for information for the drive engine to provide for processing power for processing user input from the touch screen. When receiving the interrupt, the drive engine may allocate processing power to the processing of touch screen information.

In order to further reduce power consumption, the activation of the drive engine for processing touch screen engine signals may depend upon reception of the interrupt from the touch screen engine. Embodiments provide activating the drive engine for processing signals from the touch screen engine indicative of a user input upon reception of the interrupt. The drive engine may be activated for processing the signals from the touch screen engine only when the interrupt from the touch screen engine is received. The interrupt may be issued and received, only when a user touches the touch screen at the determined areas. Touching the touch screen at areas outside the determined areas may not cause triggering of the interrupt and the drive engine may not receive the interrupt and may not provide for the necessary processing power for processing touch detection.

In order to find out, within which areas of the display user input is possible, embodiments provide analysing display information within the touch screen and selecting areas from the display information within which a user input is possible. For example, the user input may be possible within a user selection button, an icon, a character input field, a QWERTY input field, or any other field, which is capable of receiving user input. Determining these fields may, on the one hand be done by analysing the display content. On the other hand it may also be possible to receive from the respective program, which provides for the display content, information about the areas, within which user input is possible. For example, a user interface API (UI API) may provide the information, within which areas user input is possible.

According to embodiments, a user input may comprise obtaining press position information. The touch screen may allow for detecting the coordinates of a press position. Detecting the coordinates of the press position allows for detecting, whether the press position is within a determined area or not and initiating the respective operation.

Touch detection may comprise, according to embodiments, making the touch screen sensible for haptic user input. For example, users may use their fingers to input information. Also, input pens may be used. When inputting user information, in a first step the coordinates of the press position is detected. The detected coordinates may, according to embodiments, be converted within the touch screen engine into corresponding signals provided to the drive engine. The drive engine may thus control the software to operate in accordance with the user input.

A pen may be used, when a resistive touch screen is used. The resistive touch screen may utilise a change in impedance of the touch screen, when the pen is pressed onto the touch screen. When using capacitive touch screens, input may be possible using a finger. A capacitive touch screen utilises the change in capacitance of the touch screen. For example, when a finger approaches the touch screen, the capacitance of the touch screen changes, which may be evaluated and the press position may be detected. An optical touch detection may be operated using a finger or any other means touching the screen.

According to embodiments, the determination of areas, where a user input is possible, may be provided in a normal state and/or in a power safe state of at least the drive engine. For example, in the power safe state, the activation is only possible within a small icon displayed on the touch screen. Only pressing this icon may allow for activating the terminal. To reduce power consumption, activation of the drive engine, i.e. by issuing the interrupt, shall only be possible, when the activation icon is pressed. The activation icon is determined, and user input is only possible within the activation icon. Interrupts are issued only when this icon is pressed. The drive engine thus consumes less energy in the power safe state, because interrupts are only issued when the activation area is touched. The drive engine is not activated, for example, by inadvertently pressing any other area of the touch screen.

Another aspect of the specification is an apparatus comprising a touch screen, a touch screen engine, and a drive engine. The touch screen engine is arranged for determining areas, where a user input is possible. A touch screen engine is activated for sensing a user input only within the determined areas, where a user input is possible.

A further aspect of the specification is a device comprising a means for driving a touch screen, and a means for driving the device, wherein the means for driving the touch screen are arranged for determining areas within a touch screen, where the user input is possible, and wherein the means for driving the touch screen are activated for sensing a user input only within the determined areas, where a user input is possible.

The device may, according to embodiments, be, for example, a PDA, laptop, tablet PC, video player, music player, multimedia player, camera, mobile phone, or any other user device requiring user inputs.

Another aspect of the specification is a computer-readable medium having a computer program stored thereon, the computer program comprising instructions operable to cause a processor to determine areas within a touch screen, where a user input is possible, and to activate touch detection of the touch screen for sensing a user input only within the determined areas, where user input is possible.

A further aspect of the specification is a computer program comprising instructions operable to cause a processor to determine areas within a touch screen, where a user input is possible, and activate touch detection of the touch screen for sensing a user input only within the determined areas, where a user input is possible.

These and other aspects of the specification will be apparent from and elucidated with reference to the detailed description presented hereinafter. The features of the present specification and of its exemplary embodiments as presented above are understood to be disclosed also in all possible combinations with each other.

### BRIEF DESCRIPTION OF THE FIGURES

In the figures show:

FIG. 1 a block diagram of a mobile phone with its components;

FIG. 2 a side view of a touch screen;

FIG. 3 schematically a block diagram of a touch screen system;

FIG. 4 schematically a diagram of a touch screen system;

FIG. 5 schematically a display panel with pixel cells;

FIG. 6 schematically pixel cells with touch detection;

FIG. 7a a screenshot of a display within a touch screen;

FIG. 7b areas within which user input is possible of a screenshot as illustrated in FIG. 4a;

FIG. 7c a combination of screenshot of FIG. 4a and display of areas according to FIG. 4b;

FIG. 8 a flowchart of a method according to embodiments.

### DETAILED DESCRIPTION OF THE FIGURES

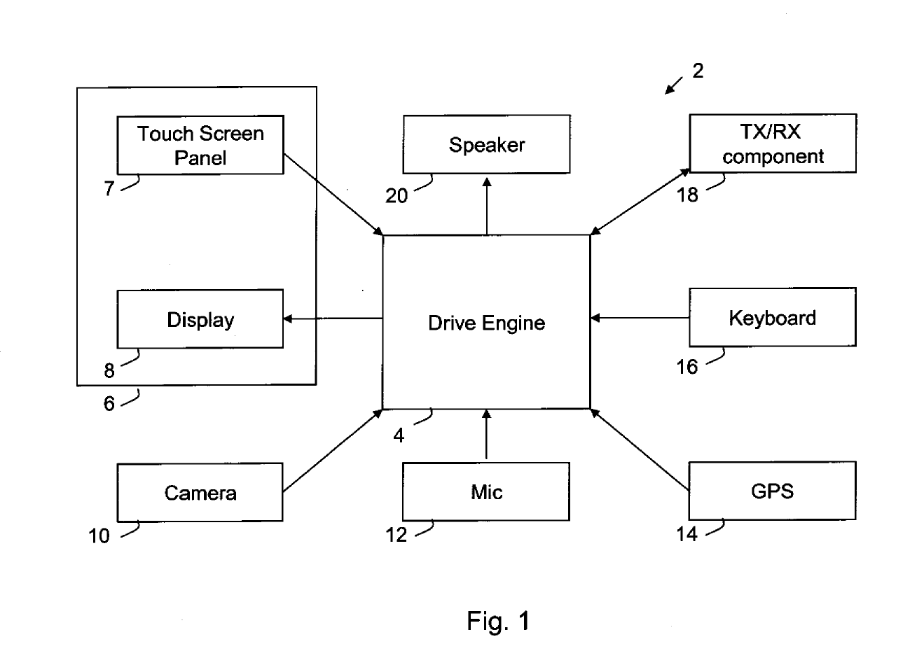

FIG. 1 illustrates schematically a block diagram of a mobile device 2. The mobile device 2 may be a terminal as previously described. Depending on which kind of device mobile device 2 is, different appliances and peripherals can be included within a mobile device 2. A selection of possible appliances and peripherals are shown in FIG. 1. It should be noted, that the selection of shown appliances and peripherals is illustrative only and shall not be understood as limiting.

As illustrated in FIG. 1, mobile device 2 is a mobile phone having a drive engine 4. Drive engine 4 may be comprised of hardware and software. Drive engine 4 may be capable of operating all peripherals and any kind of software necessary for operating the peripherals. Drive engine 4 may be a microprocessor, which processes the mobile device 2 according to different standards, applications, and the like. Drive engine 4 may be understood as the core engine of the mobile device 2, which is responsible for the operation and interoperation of programs and appliances, which are hereinafter explained.

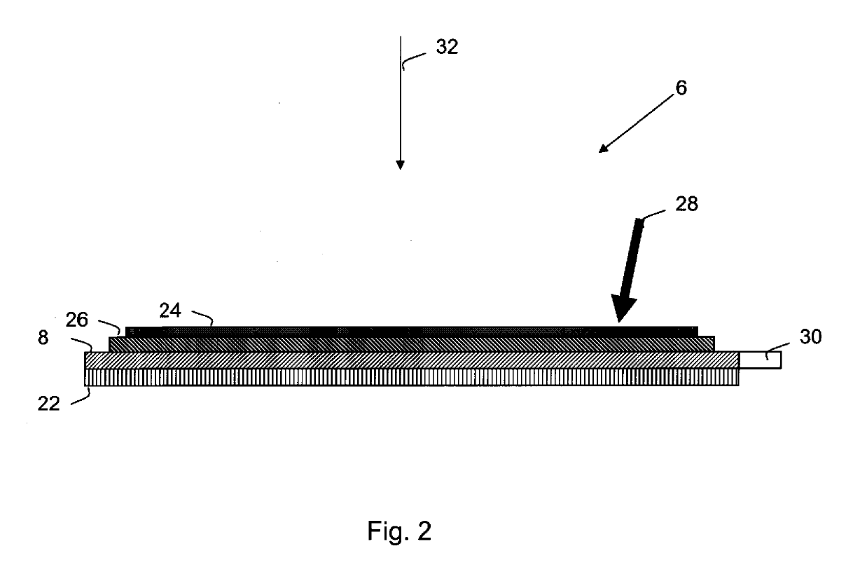

A touch screen 6 may comprise a touch screen panel 7. Touch screen panel 7 may be placed in front of a display 8. The touch screen panel may also be incorporated within display 8. Touch screen panel 7 may be operated by a touch screen engine, i.e. a touch screen controller (not depicted). Touch screen panel 7 and display 8 may be connected to drive engine 4. Touch screen panel may comprise a touch screen controller and may be a component, which is converting physical touches onto its surface or the surface of the display 8 into an electrical format, i.e. signals for drive engine 4 for operating programs and other appliances. Touch screen 6 will be further illustrated with reference to FIG. 2.

Spatially beneath touch screen panel 7, a display 8 may be arranged. Display 8 may be a component, which is converting electrical information received from the drive engine 4 into a readable format. This information may be any information generated from a software for controlling a user interface. Display 8 may be an LED display, OLED display, TFT display, CRT display, plasma display, or any other kind of display capable of converting information into a user readable format. The display 8 receives display information from drive engine 4 and puts out this information as optical information.

Further connected to drive engine 4 may be camera 10. The camera 10 may be a component, which is converting image information into a suitable format for further processing by drive engine 4.

Microphone 12 may be a component, which is converting audio information from acoustic waves into electrical information. Microphone 12 may receive user input via acoustic waves and may input these to drive engine 4.

Further, connected to drive engine 4 is GPS receiver 14, which is a component for converting position information, i.e. from satellites into respective position information for drive engine 4.

Further, keyboard 16 may be connected to drive engine 4. Keyboard 16 may be a component, which is converting information from depressed keys into signals for drive engine 4 for receiving user input.

Further connected to drive engine 4 is a transmission and reception component 18. This component 18 may allow for wired and wireless communication with any kind of other communication hardware. For example, GSM and UMTS communication may be possible via component 18. Further, NFC, WiFi, or any other wireless communication may be possible. Component 18 may allow communicating via LAN, WAN or any other wired communication line.

Information from the mobile device 2 may be output via loudspeaker 20. Loudspeaker 20 may be a component for converting electric information into acoustic waves.

The specification relates to the operation of touch screen 6, i.e. touch screen panel 7, display 8 and drive engine 4. Power consumption of drive engine 4 shall be reduced by controlling touch screen panel 7 appropriately. Touch screen 6 is further illustrated in FIG. 2.

FIG. 2 illustrates a side view onto a touch screen 6 with a display 8. Display 8 is arranged above a light guide 22 and covered by protection sheets 24. Between protection sheets 24 and display 8, there is arranged a touch detection sheet 26, which enables the touch screen 6, i.e. the touch screen controller, to detect a touch position of, for example, a touch pen 28. The display 8 may driven by a display driver 30. Display driver 30 may provide display 8 with display information, which is being displayed on display 8 and can be seen from a user's viewing direction 32. The display information may be received from the drive engine 4 via a flex-foil connection (not depicted), or any other kind of electrical connection.

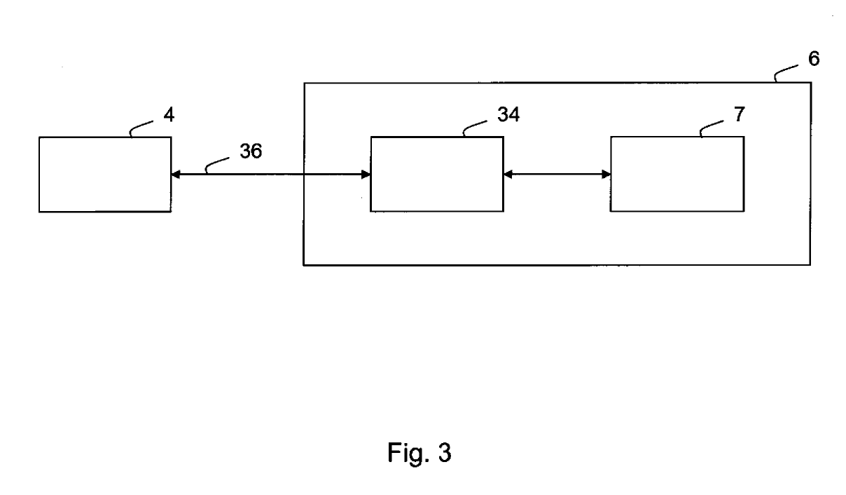

Display 8, light guide 22, protection sheets 24, and touch detection sheets 26 may in common or in any combination thereof be understood as touch screen 6. Touch screen 6 may be connected to the drive engine 4 via an electrical connection, as will be shown in FIG. 3.

Touch screen panel 7 may be comprised of a touch screen engine and touch detection sheets 26.

Light guide 22 may be connected with a back lighting controller (not depicted) and provides the display 8 with back light, so that the content being displayed on display 8 and provided through display driver 30 can be seen even in dark viewing conditions.

By means of a pen 28, a user may select a certain icon or item being displayed on display 8. This may be done by detecting the press position of pen 28 on touch screen 6 using the touch detection sheet 26.

The touch detection and position detection is provided by a touch screen controller (not depicted), a.k.a. touch screen driver, being further illustrated in FIG. 3. The touch screen driver may be a microprocessor running a program suitable for controlling the touch screen 6, and/or the touch detection sheet 26 and for obtaining touch information from touch screen 6 and/or the touch detection sheet 26.

FIG. 3 illustrates a touch screen 6 being connected with touch screen controller 34. Touch screen controller 34 is connected with drive engine 4 via interrupt line 36. When the user touches the touch screen 6, using the touch pen 28 or his finger, touch screen 6 provides for touch detection information to touch screen controller 34. Upon touch detection, touch screen controller 34 provides for an interrupt via interrupt line 36 to drive engine 4 in order to activate drive engine 4 for processing user input through touch screen 6.

When touch screen 6 is activated through its whole area, and user input is possible through the whole area of touch screen 6, touch screen controller 34 issues an interrupt to drive engine 4 every time touch screen 6 is touched, no matter where the touch detection locates the area, where touch screen 6 is touched. This leads to issuing a plurality of interrupts on interrupt line 36.

Engine 4 is activated every time touch screen 6 is touched, even if the touch detection is not within areas, which allow or require user input. This leads to increased power consumption, as drive engine 4 needs to allocate processing power for detecting user input through touch screen 6 every time it receives an interrupt.

In power safe mode, when the touch screen 6 should only be activated upon a touching certain area, the commonly known touch screen 6 always activates drive engine 4 after touch detection, after which it is checked, whether a terminal is to be activated or not. This leads to increase power consumption.

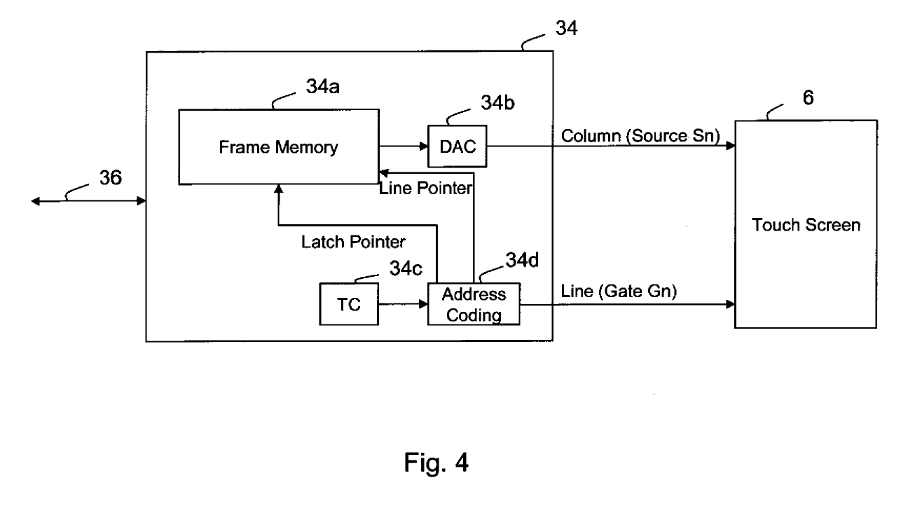

FIG. 4 illustrates in more detail a touch screen controller 34. As illustrated, touch screen controller 34 in connected to a drive engine 4 via an interface 36, which may be a flex foil interface 36. Through interface 36, touch screen controller 36 may receive display information and may send touch detection signals. Touch screen controller 34 may be comprised of a frame memory 34a. The image information is provided column by column through D/A converter 34b to display panel 6. A timing controller 34c may provide clocking signals for selecting line addresses. The line addresses are provided to display 6 and also to frame memory 34a by address coder 34d. Through the line addresses, the display 6 is activated line by line and the respective pixel information for the respective lines is provided through frame memory 34a.

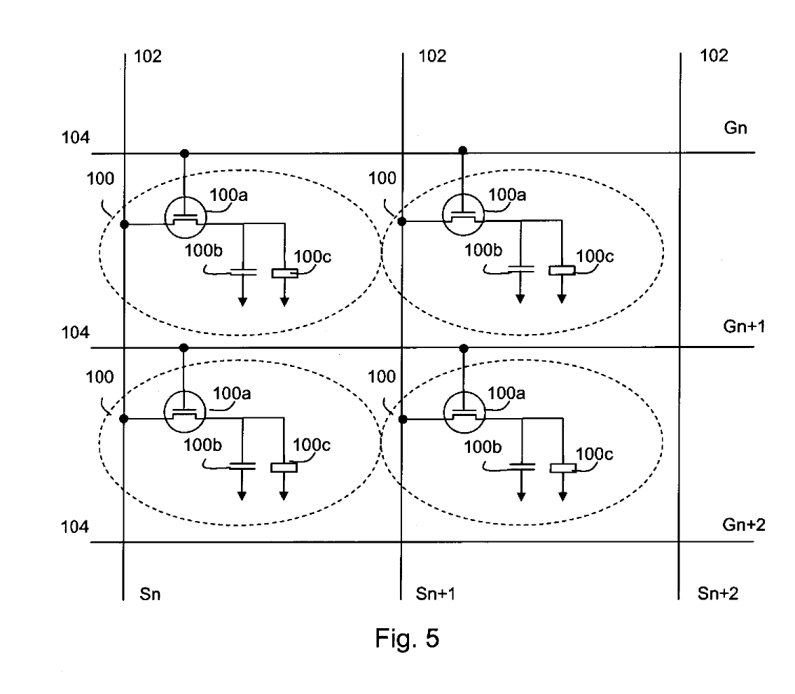

FIG. 5 illustrates several pixel cells 100 within a touch screen 6. Each pixel cell 100 may represent one pixel.

The pixel cell 100 may be comprised of transistor 100a, capacitor 100b, and liquid crystal cell 100c.

The column selection for a pixel cell 100c may be done by activating the respective source line 102 (Source: Sn, Sn+1, Sn+2). The source lines 102 may be connected to DAC 34b for receiving pixel data. The row selection may be done through gate line 104 (Gate: Gn, Gn+1, Gn+2, etc.) signals. Gate lines 104 may be connected to address coding 34d.

When source line 102 and gate line 104 for a particular transistor 100a are activated, the respective liquid crystal cell 100c at pixel cell 100 is activated, and the pixel cell 100c shows the image data, i.e. light intensity and color, for this respective pixel in the image.

The block diagram of the pixel cells 100 as illustrated in FIG. 5 is working as follows

Image data is input from interface 36, which source is drive engine 4, to the frame memory 34a on the touch screen controller 34. Timing controller 34e sends timing information to address coding 34d which generates control signals for controlling the line selection.

The line selection within address coding 34d may read location information from the frame memory 34a by using a latch pointer and a line pointer.

The digital image data is input to Digital-Analog-Converter (DAC) 34b. The data is converted to an analogue image data for a certain column 102, being represented by the source line 102.

The analogue image data is also inputted to the display panel for line selection. The location of each displayed pixel is controlled by address coding block 34d via source lines 102 and gate line 204 control signals.

The gate line control signal may have digital values (‘0’ or ‘1’), which may be used for selected a line of the pixel on the display panel. The pixel value of a certain column, being stored as digital information of the image data, may then be provided through source lines 102, respectively.

For a visible pixel the source line 102 and gate line 104 are activated and the displayed pixel value represents the analogue value of the respective source line 102.

When illuminating one pixel cell 100c, the analogue image data, i.e. the current at source line 102, can flow through transistor 100a and load charging capacitor 100b. This loading is continued until there is selected another gate line by setting another gate line 104 HIGH.

The loading of capacitor 100b controls the brightness of liquid crystal cell 100c of the pixel cell 100. The loaded capacitor 100b keeps the analogue value, i.e. the visible grey level of the pixel cell 100, until the same gate line 104 is selected again and a new loading is carried out.

The pixel cell 100, which is visible, is working as follows

Analogue image data is output on the source lines 102 (Sn, Sn+1, Sn+2, etc.). A selection, which is the used gate line 104, where all pixel cells 100 are updated, is further output by setting the respective gate line HIGH.

The HIGH gate line 104 represents the line of the pixel cell 100, which are updated at the same time. The pixel cells 100 in other lines are not updated. This update is starting on one of the edges of the display panel 6 and after the start, every next line (e.g. from Gn=>Gn+1=>Gn+2, etc.) is updated until the opposite side of the display panel 6 is reached. Then, the updating can be started from the beginning again.

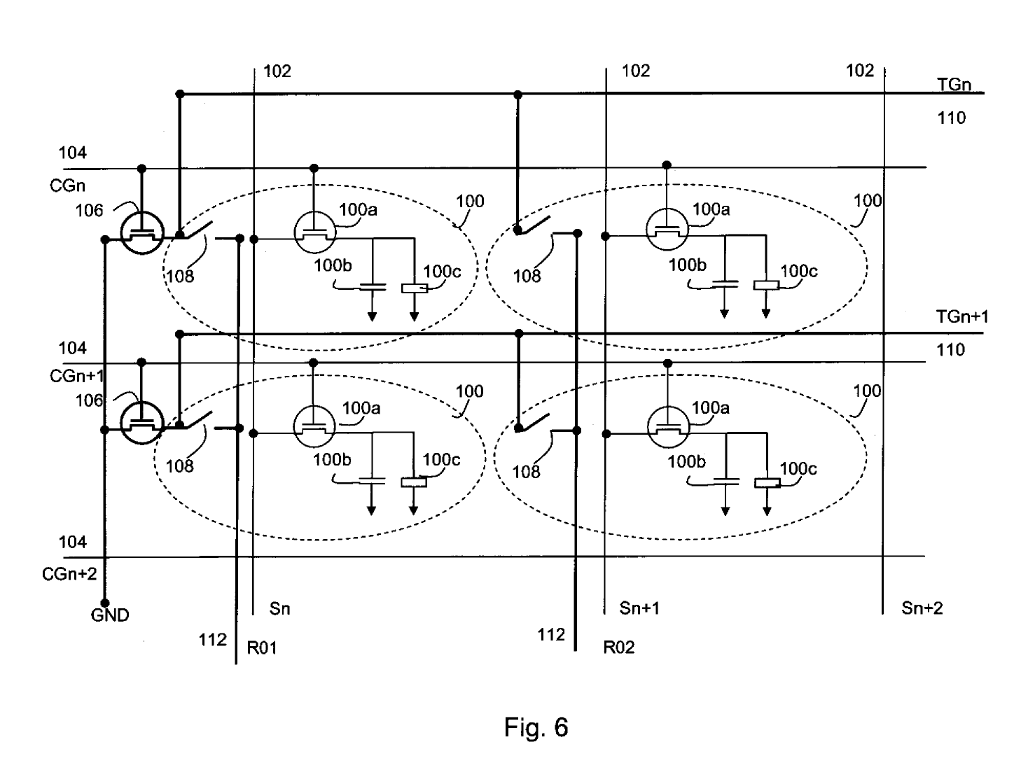

In order to reduce power consumption, the interrupts need to be reduced. Therefore, embodiments provide for determining areas within a touch screen, where a user input is possible and activating touch detection of the touch screen for sensing a user input only within the determined areas, where a user input is possible. This detection of areas, where user input is possible, is further illustrated in FIGS. 6-9.

FIG. 6 illustrates pixel cell 100 as illustrated in FIG. 5, further comprising transistors for touch detection 106. Pixel cell 100 further comprises touch detection sensors 108. The selective touch detection works as follows:

The gate driver includes same amount of the lines what are used for display panel 6 as illustrated in FIG. 5. These lines are indicated as common gate lines 104 CGn, CGn+1, GCn+1, etc.

When the common gate line 104 are set HIGH, the transistors for touch detection 106 are presumably activated in the same way and time when the transistors 100a of pixel cell 100 on the display panel 6 are activated.

For detecting touches on the display panel 6, it is checked, whether a touch screen sensor 108 of pixel cell 100 is depressed. That means that only for those lines, where the CGn line 104 is active, touch sensors 108 are read out.

When it is desired that only selected areas of the display panel 6 can be read out, i.e. are active for touch detection, it may be possible to omit the transistors for touch detection 106 but to provide HIGH and LOW states to the touch sensors 108 through separate touch screen gate lines 110 (TGn, Tgn+1). The state of touch screen gate lines 110 can be selected such that only those touch screen gate lines are HIGH, where user input is possible. This may be detected through analysing the content of the image. By only activating the relevant touch screen gate lines 110, only within those touch sensors 108, which are connected to the touch screen gate lines can be read out.

In order to further select, which column is capable of touch detection, read out lines 112 (R01, R02) may be used. Only those read out lines 112 may be read out, where touch detection is possible, or desired. This results in the possibility to selectively choose the pixel cells 100, where touch detection is possible.

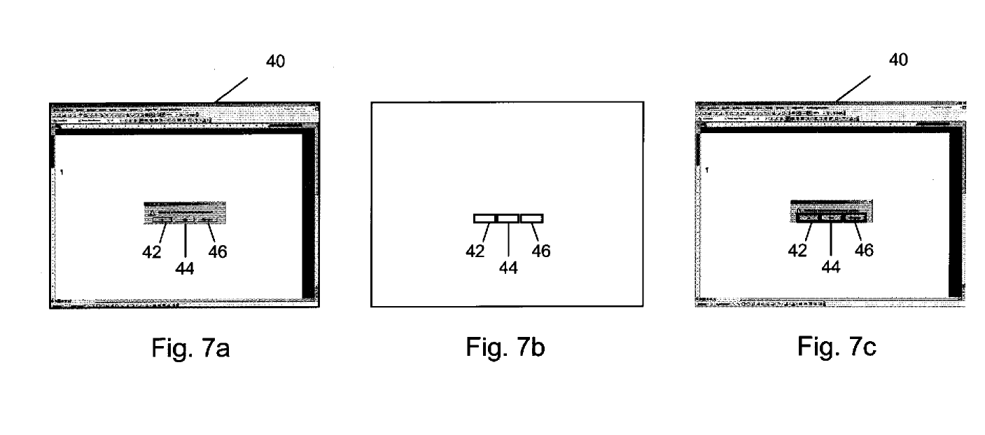

FIG. 7a illustrates a screenshot of a user interface 40. The screenshot is a program window. Within this program window, it is possible to input user information only at certain areas. In the displayed user interface 40, the program requires the user to input a selection of “yes”, “no”, or “cancel”. As can be seen in FIG. 4a, user interface 40, being displayed on display 8, allows input only within the areas 42, 44, 46, being input buttons.

Touching the touch screen on any other position than the buttons 42, 44, 46, would not result in a reaction of the program. Only touching of any of the buttons 42, 44, 46, allows the program to move to its next state. In order to suppress interrupts being sent from touch screen controller 34 to engine 4, when the display is touched at positions outside buttons 42, 44, 46, it is necessary to determine these areas.

The result of this determination is illustrated in FIG. 7b. FIG. 7b is a representation of user interface 40, where the locations of buttons 42, 44, 46 are highlighted. The highlighted areas of buttons 42, 44, 46, represent areas, within which touch screen 6 is activated, i.e. reacts on user input. In other areas the touch screen 6 is not sensible for touch detection, i.e. when areas other than the buttons 42, 44, 46 are touched there is no reaction of the touch screen 6. In other words, the respective touch screen gate lines 110, where the buttons 42, 44, 46 are located, are set to HIGH. Further, the horizontal position of the buttons 42, 44, 46 determines, which read out lines 112 are actually read out. This results in only detecting touches on the display 6 in the areas of the buttons 42, 44, 46.

FIG. 7c illustrated an overlay of the activated areas and buttons 42, 44, 46 in user interface 40. User input is only possible at buttons 42, 44, 46. The user can select one of buttons 42, 44, 46 and an interrupt is issued to engine 4 via touch screen controller 34. Touching the touch screen 6 on any other position does not result in issuing such an interrupt.

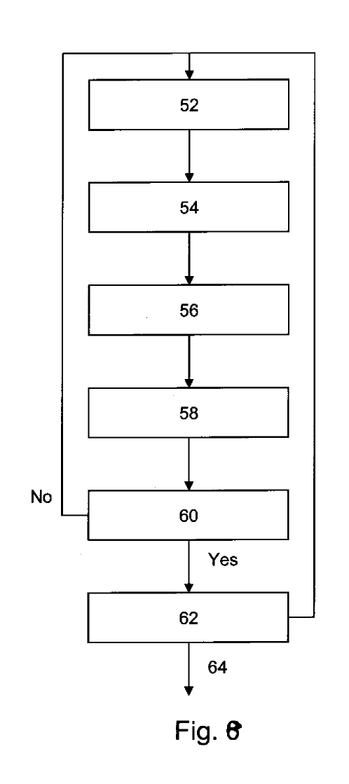

FIG. 8 illustrates a flowchart of a method according to embodiments. Display controller receives (52) display information for being displayed on display 8. The display information is forwarded (54) to touch screen controller 34. Within touch screen controller 34, the display information is analysed, and it is determined (56), where areas are located, where user input is possible. It is also possible, that a user interface API is requested by touch screen controller 34 to give information about where areas are located where a user input is possible.

After having determined (56) the areas, where user input is possible, the information for being displayed is displayed (58) on display 8. Besides that the touch screen 6 and touch screen controller 34 are arranged (60) such that they do only react on user input at the determined areas. If no user input at the determined areas is detected, the next image is being evaluated and displayed (52-58).

If a user input is detected within the areas, where user input is possible, touch screen controller 34 issues (62) an interrupt for drive engine 4. The issuance of the interrupt initiates within drive engine 4 the appropriate program logic, and the program is further processed (64) according to the user input. This may be done by further detecting user inputs or by proceeding with the program logic. For example, proceeding program logic may result in storing certain results.

It should be understood that issuing the interrupt and carrying out program logic (62, 64) consumes energy. Thus, issuing the interrupt should only occur, when the touch screen 6 is touched at areas, where user input is possible.

With the touch screen according to the specification, touch detection is only carried out within the areas where user input is possible. Only touching the touch screen at these positions results in an issuance of an interrupt for engine 4 and further processing of a program logic. Power consumption is reduced only to cases where the touch screen is touched at areas, where user input is possible and expected. This results in a reduction of power consumption of device 2.

The specification has been described above by means of exemplary embodiments. It should be noted that there are alternative ways and variations which are obvious to a skilled person in the art and can be implemented without deviating from the scope and spirit of the appended claims.

Furthermore, it is readily clear for a skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. The computer software may be stored in a variety of storage media of electric, magnetic, electro-magnetic or optic type and may be read and executed by a processor, such as for instance a microprocessor. To this end, the processor and the storage medium may be coupled to interchange information, or the storage medium may be included in the processor.

1-23. (canceled)

24. A method, comprising:
determining at least one area within a touch screen where user input is possible; and
activating touch detection of the touch screen to sense user input for the at least one area, wherein an apparatus comprises the touch screen, a touch screen engine and a drive engine.

25. A method according to claim 24, further comprising issuing an interrupt for the drive engine when sensing a user input.

26. A method according to claim 24, further comprising activating the drive engine to process signals from the touch screen engine indicative of the user input upon reception of an interrupt.

27. A method according to claim 24, wherein the determining comprises analysing display information within the touch screen and selecting the at least one area from the display information for which user input is possible.

28. A method according to claim 24, wherein the at least one area comprises at least one of a user selection button, character input field and QWERTY input field.

29. A method according to claim 24, wherein the sensing the user input comprises obtaining press position information.

30. A method according to claim 24, wherein the activating comprises enabling haptic user input sensing for the touch screen.

31. A method according to claim 24, wherein the user input is converted within the touch screen engine into corresponding signals provided to the drive engine.

32. A method according to claim 24, wherein sensing user input comprises at least one of capacitive, resistive and optical touch detection.

33. A method according to claim 24, wherein determining the at least one area is provided in at least one of a normal state and a power save state of the drive engine.

34. An apparatus, comprising:
a touch screen;
a touch screen engine; and
a drive engine,
the touch screen engine being configured to determine at least one area within the touch screen where user input is possible and to be activated to sense user input within the at least one area.

35. An apparatus according to claim 34, wherein the touch screen engine is configured to issue an interrupt for the drive engine when user input is sensed.

36. An apparatus according to claim 35, wherein the drive engine is configured to be activated to process at least one signal from the touch screen engine indicative of a user input upon reception of the interrupt.

37. An apparatus according to claim 34, wherein the touch screen engine is configured to analyze display information within the touch screen and to select the at least one area from the display information for which a user input is possible.

38. An apparatus according to claim 34, wherein the at least one area comprises at least one of a user selection button, character input field and QWERTY input field.

39. An apparatus according to claim 34, wherein the touch screen engine is configured to sense the user input by obtaining press position information.

40. An apparatus according to claim 34, wherein the touch screen is configured to sense haptic user input.

41. An apparatus according to claim 34, wherein the touch screen engine is configured to convert the user input into corresponding signals, and further to provide the converted signals to the drive engine.

42. An apparatus according to claim 34, wherein the touch screen is configured for at least one of capacitive touch detection, resistive touch detection and optical touch detection.

43. An apparatus according to claim 34, wherein the touch screen engine is further configured to determine the at least one area during a normal state and a power save state of the drive engine.

44. A computer-readable medium having a computer program stored thereon, the computer program comprising:
instructions operable to cause a processor to determine at least one area within a touch screen where user input is possible and activate touch detection of the touch screen to sense a user input within the at least one area.

45. A computer program product, comprising:
instructions operable to cause a processor to determine at least one area within a touch screen where user input is possible and activate touch detection of the touch screen to sense a user input within the at least one area.
